(19) United States
(12) Patent Application Publication
(10) Pub. No.: US 2012/0250636 A1
(43) Pub. Date: Oct. 4, 2012

(54) Effective Labeling of Subframes Based on Device-to-Device Transmission in Cellular Downlink Spectrums

(75) Inventors: Haiming Wang, Beijing (CN); Shaoyi Xu, Beijing (CN); Tao Peng, Beijing (CN)

(73) Assignee: NOKIA CORPORATION, Espoo (FI)

(21) Appl. No.: 13/376,334

(22) PCT Filed: Apr. 6, 2010
(86) PCT No.: PCT/FI10/50263

§ 371 Date: Mar. 14, 2012

Related U.S. Application Data
(60) Provisional application No. 61/184,242, filed on Jun. 4, 2009.

(51) Int. Cl. H04W 72/04; H04W 24/10

(52) U.S. Cl. 370/329

(57) ABSTRACT

Methods and apparatus, including computer program products, are provided for allocating resources among user elements. In one aspect there is provided a method. The method may include receiving, at a base station, information from a user element. The information may include at least one bit representing whether direct transmissions between pairs of user elements cause interference to the user element. The base station may schedule, based on the received information, the user element into at least one of a first subframe, when the received information indicates a risk of interference from the direct transmissions between the pairs of user elements, and into a second subframe, when the received information indicates no risk of interference from the direct transmissions between the pairs of user elements. Related apparatus, systems, methods, and articles are also described.

### FIELD

The subject matter described herein relates to wireless communications.

### BACKGROUND

There are various types of network configurations, including a cellular network, an ad-hoc network, or a combination of both. In the case of the cellular network, the user element communicates (e.g., transmits and/or receives) with another user element through a base station. In the case of the ad-hoc network, the user element communicates directly with another user element.

In the cellular network, the user element communicates information (e.g., traffic) to another user element through the base station, such as an evolved Node B (eNB) type base station operating as a centralized controller. Indeed, the user elements communicate with the base station even when the two user elements are close to each other. A benefit of the base station approach is direct resource control and interference control, but the drawback is, in some cases, the inefficient utilization of resources. For example, twice the resources will be required for a cellular network mode of communications when compared to a direct transmission between user elements (when they are close to each other) as one link is required between the user elements rather than two links (e.g., one link from the user element to the base station and another link from the base station to the second user element). In some instances, using a mix of cellular and ad-hoc may provide better use resource utilization and achieve enhanced system throughput.

### SUMMARY

The subject matter disclosed herein provides resource sharing among user elements.

In one aspect there is provided a method. The method may include receiving, at a base station, information from a user element. The information may include at least one bit representing whether direct transmissions between pairs of user elements cause interference to the user element. The method may also include scheduling, based on the received information, the user element into at least one of a first subframe, when the received information indicates a risk of interference from the direct transmissions between the pairs of user elements, and into a second subframe, when the received information indicates no risk of interference from the direct transmissions between the pairs of user elements.

In another aspect, there is provided a method. The method may include monitoring, by a user element, a channel used to signal direct transmissions between a pair of user elements; and sending, by the user element to a base station, a message reporting information monitored from the channel, the message including at least one bit representing whether direct transmissions causing interference are near the user element.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a block diagram of a wireless communication system 100 including a mixed network of cellular and device-to-device (D2D) user elements;

FIG. 2 depicts a frame structure 200;

FIG. 3A depicts a portion of wireless communication system 100;

FIG. 3B depicts a process 390 configured at a base station to allocate resources among user elements;

FIG. 4 depicts subframe allocations for cellular and D2D user elements;

FIG. 5 depicts another process 500 for allocating resources among user elements;

FIG. 6 depicts a power saving scheme;

FIG. 7 depicts an example implementation of a base station; and

FIG. 8 depicts an example implementation of the user element.

Like labels are used to refer to same or similar items in the drawings.

### DETAILED DESCRIPTION

The subject matter described herein relates to integrating ad-hoc transmission (referred to herein as device-to-device (D2D) transmissions) into the control aspects of a cellular network, such as an LTE or an LTE-Advanced cellular network, although the subject matter described herein may be implemented in other types of cellular networks as well. The subject matter described herein provides a mechanism to share the downlink resources while avoiding near-far interference in a mixed network by using what is referred to herein as “labeled subframes.”

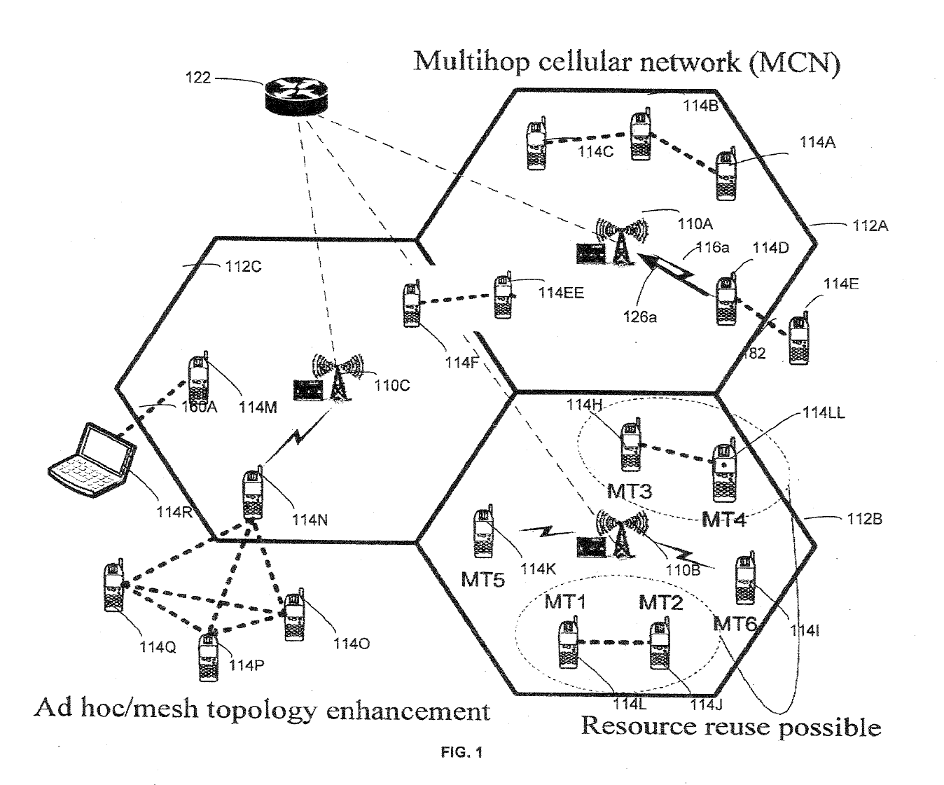

FIG. 1 depicts an example of a wireless communication system 100 including a cellular network and an ad-hoc network configured to allow D2D. The wireless communication system 100 includes user elements 114A-Q, base stations 110A-C, coverage areas 112A-C, a control node 122 (e.g., a gateway, router, etc.). The base stations, such as base station 110A, transmit to the user elements, such as user element 114D, via a downlink, such as downlink 116A. The base stations receive a transmission from the user elements via an uplink, such as uplink 126A. The user element 114A may choose to communicate directly to user element 114B using a direct link 182, such as a D2D link, or choose to communicate with user element 114B through base station 110A.

The base stations 110A-C each support a corresponding service or coverage area 112A-C (also referred to as a cell). The base stations 110A-C are capable of communicating with wireless devices within their coverage areas. For example, the first base station 110A is capable of wirelessly communicating (e.g., transmitting and/or receiving) with user elements 114A-E; and base station 110B is capable of wirelessly communicating with user elements 114G-L; and so forth in coverage area 112C. Moreover, base station 110A may also be able to communicate with user element 114F since user element 114F is near the edge of both coverage areas 112A-C.

In some implementations, base stations 110A-C may be implemented as an evolved Node B (eNB) type base station consistent with standards, including the Long Term Evolution (LTE) standards, such as 3GPP TS 36.201, “Evolved Universal Terrestrial Radio Access (E-UTRA); Long Term Evolution (LTE) physical layer; General description,” 3GPP TS 36.211, “Evolved Universal Terrestrial Radio Access (E-UTRA); Physical channels and modulation,” 3GPP TS 36.212, “Evolved Universal Terrestrial Radio Access (E-UTRA); Multiplexing and channel coding,” 3GPP TS 36.213, “Evolved Universal Terrestrial Radio Access (E-UTRA); Physical layer procedures,” 3GPP TS 36.214, “Evolved Universal Terrestrial Radio Access (E-UTRA); Physical layer-Measurements,” and any subsequent additions or revisions to these and other 3GPP series of standards (collectively referred to as LTE standards). The base stations 110A-C may also be implemented consistently with the Institute of Electrical and Electronic Engineers (IEEE) Standard for Local and metropolitan area networks, Part 16: Air Interface for Fixed Broadband Wireless Access Systems, 1 Oct. 2004, IEEE Standard for Local and metropolitan area networks, Part 16: Air Interface for Fixed and Mobile Broadband Wireless Access Systems, 26 Feb. 2006, IEEE 802.16m, Advanced Air Interface, and any subsequent additions or revisions to the IEEE 802.16 series of standards (collectively referred to as IEEE 802.16).

The user elements may communicate directly with each other to bypass the base station, as noted above. When this is the case, the user element transmits via a direct link (e.g., as a Bluetooth link, WiFi link, etc.) to the other user element, and receives via a direct link from the other user element. These direct user element to user element transmissions are referred to as device-to-device (D2D) transmissions (also referred to as mobile-to-mobile (M2M) transmissions, terminal-to-terminal (T2T) transmissions, and peer-to-peer (P2P) communications). Moreover, the D2D transmissions are integrated into the control aspects of a cellular network, such as an LTE or an LTE-Advanced cellular network specified in 3GPP, although the subject matter described herein may be implemented in other types of cellular networks as well.

Although the base stations 110A-C are described as eNB type base stations, the base stations 110A-C may be configured in other ways as well and include, for example, cellular base station transceiver subsystems, gateways, access points, radio frequency (RF) repeaters, frame repeaters, and include access to other networks as well. For example, base stations 110A-C may have wired and/or wireless backhaul links to other network elements, such as node 122, as well as other base stations, a radio network controller, a core network, a serving gateway, a mobility management entity, a serving GPRS (general packet radio service) support node, and the like.

The user elements 114A-R may be implemented as a mobile device and/or a stationary device. The user elements 114A-R are often referred to as, for example, mobile stations, mobile units, subscriber stations, wireless terminals, or the like. A user element may be implemented as, for example, a wireless handheld device, a wireless plug-in accessory, or the like. In some cases, a user element may include a processor, memory, a radio access mechanism, and a user interface. For example, the user element may take the form of a wireless telephone, a computer with a wireless connection to a network, or the like. Although for simplicity only three base stations and eighteen user elements are shown, other quantities of base stations and user elements may be implemented in wireless communication system 100.

In some implementations, the downlinks, such as downlink 116A, and the uplinks, such as uplink 126A, each represent a radio frequency (RF) signal. The RF signal may include data, such as voice, video, images, Internet Protocol (IP) packets, control information, and any other type of information. When IEEE-802.16 and/or LTE are used, the RF signal may use OFDMA. OFDMA is a multi-user version of orthogonal frequency division multiplexing (OFDM). In OFDMA, multiple access is achieved by assigning, to individual users, groups of subcarriers (also referred to as subchannels or tones). The subcarriers are modulated using BPSK (binary phase shift keying), QPSK (quadrature phase shift keying), or QAM (quadrature amplitude modulation), and carry symbols (also referred to as OFDMA symbols) including data coded using a forward error-correction code. Moreover, in some implementations, the wireless communication system 100 can be configured to comply substantially with a standard system specification, such as LTE or other wireless standards, such as WiBro, WiFi, IEEE 802.16, or it may be a proprietary system. The subject matter described herein is not limited to application to OFDMA systems, LTE, or to the noted standards and specifications. The description in the context of an OFDMA system is offered for the purposes of providing a particular example only.

Transmissions among nodes of wireless communication system 100 may be controlled in accordance with a frame structure defining an allocation, e.g., when a transmission occurs and what is transmitted (as well as when a receiver should receive and what is received). For example, the frame structure may define the allocation, which may be in terms of one or more of a time, a subframe, a frequency, a block, a symbol, an OFDM symbol, or the like, to an uplink, a downlink, a control channel (e.g., dedicated common control channel (CCCH)), user elements communicating via D2D transmissions, and/or the like. The frame structure may allow the downlink from the base station, the uplink from the user elements (which is received by the base station), and pairs of user elements communicating via D2D transmission (also referred to herein as D2D user elements) to coordinate transmission, sharing thus the allocated resources.

In the case of the downlink between a base station and a user element, the base station, such as an eNB of an LTE or LTE-Advanced cellular network, transmits nearly continuously, e.g., control signaling an/or data. Moreover, the base station may use fast scheduling to allocate portions of the downlink (e.g., portions of the frame structure) to user elements. As such, a user element implementing D2D shares spectrum with the base station and other user elements, but this sharing may be difficult due to the nearly continuous use of the spectrum by the base station, as noted above. To share the spectrum used by the downlink (e.g., downlink 116A), one way to allocate the spectrum is by implementing a static frequency allocation to share, or split, the resources, which would be shared among the base station, corresponding user elements, and D2D user elements communicating via a D2D transmission. However, a static, fixed allocation of the frequency spectrum may not be considered efficient. Nor is it considered practical.

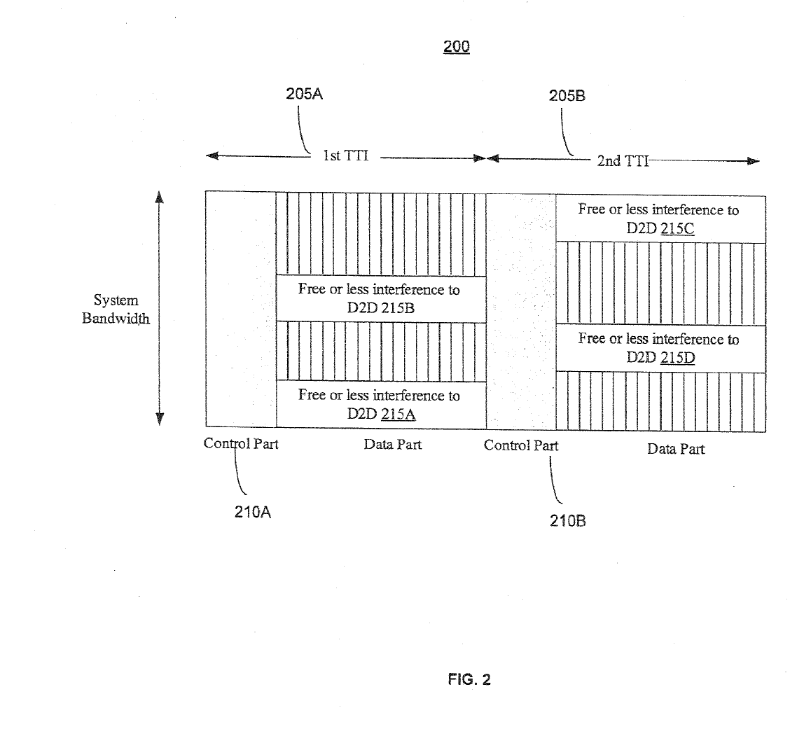

FIG. 2 depicts a frame 200 depicting fast scheduling in the downlink, such as downlink 116A, between a base station, such as base station 110A, and user element, such as user element 114D. For example, in the case of a downlink configured in accordance with LTE, resources are dynamically allocated in each transmission time interval (TTI), but a single TTI is not sufficient for D2D user elements to decode the available resources and then perform D2D transmissions. In the first TTI 205A, a D2D user element decodes the control part 210A of frame 200, and, as a consequence, the D2D user element determines which resources are available to perform D2D communications. However, in the a subsequent, second TTI 205B, before the D2D user element performs radio resource management (RRM) to actually proceed with the D2D transmission using the previously allocated resources, the available resources for D2D have changed. Referring to FIG. 2, the D2D user element decodes control part 210A, proceeds with radio resource management in order to use the allocated resource of 215A-B, but before the radio resource management (or for that matter D2D transmission even begins) another control part 210B is received by the D2D user element. The control part 210B directs the D2D user element to use another resource allocation 215C-D for the D2D transmission. Thus, the D2D user element is not able to use its resource allocation (e.g., portion of the spectrum, subframes, OFDMA symbols, etc.) quickly enough before the base station, which controls the user element using fast scheduling, changes the resource allocation.

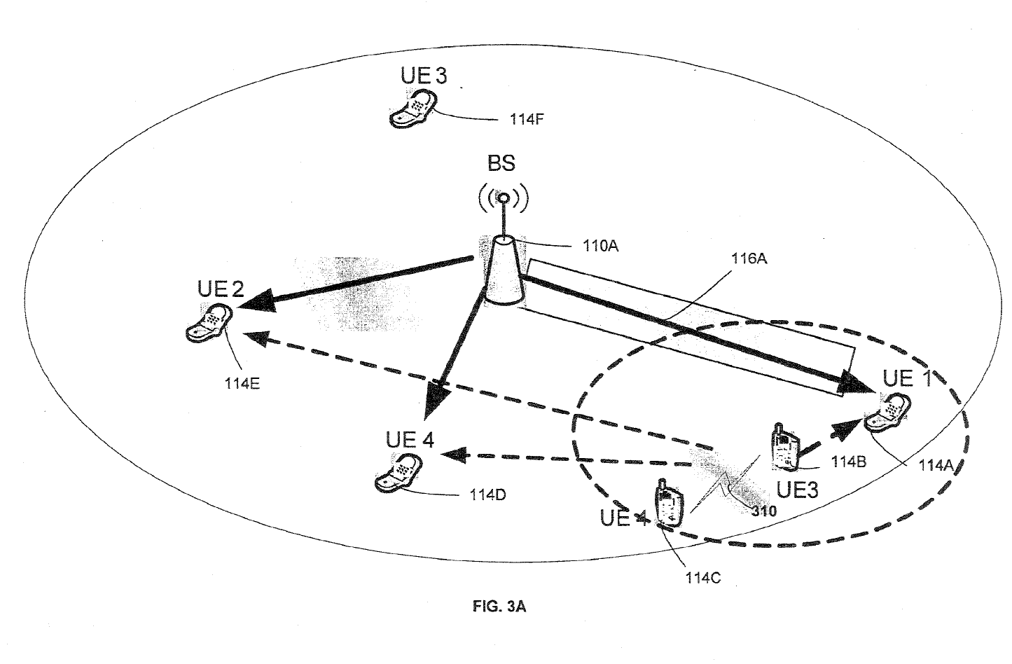

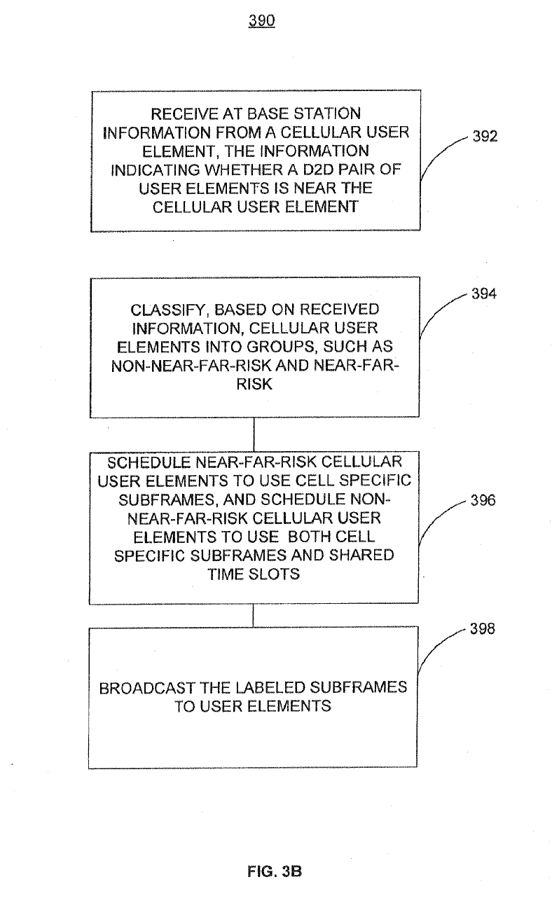

FIG. 3A depicts a portion of wireless communication system 100, namely coverage area 112A including base station 110A and user elements 114A-E. FIG. 3A depicts the near-far interference among user elements communicating using D2D (referred to as D2D user elements) and user elements communicating with a base station (referred to as cellular user elements), when the user elements 114A-E are allocated the same downlink resources, such as the same frequencies, subframes, OFDMA symbols, etc. As can be seen, D2D user elements 114B and 114C communicate via direct links 310, but may experience a significant amount of interference (e.g., near-far radio frequency interference) from the downlink 116A to user element 114A, as the distance between user element 114A and user elements 114B-C is relatively small.

In FIG. 3A, the user elements 114A-E and downlink 116A must share resources in order to communicate, but must share the resources with little or no interference.

In some implementations, the wireless communication system 100 may be configured, such that the D2D user elements share (e.g., use) the downlink spectrum of the cellular system with the cellular user elements. Moreover, the wireless communication system 100 may be configured, such that a CSMA/CA (carrier sense multiple access/collision avoidance) type MAC (media access control) protocol is applied for the D2D transmission. When that is the case, a common control channel (CCCH) is dedicated to control (e.g., via a handshaking procedure) D2D transmissions, wherein signals (e.g., request to send (RTS), clear to send (CTS), acknowledgement (ACK), and non-acknowledgement (NACK)) are transmitted via the CCCH to facilitate radio resource management (RRM) and D2D transmission. Furthermore, the wireless communication system 100 may be configured, such that the D2D user elements can transmit via the entire spectrum allocated to the downlink and the corresponding cellular user elements, when the D2D user elements are close to each other and can avoid the near-far interference from an eNB.

FIG. 3B depicts a process 390 to share the use of resources among D2D user elements and cellular user elements in a mixed network, such as wireless communication system 100.

At 392, a base station, such as base station 110A, receives information from a cellular user element. The received information indicates whether D2D user elements are transmitting close the cellular user element. For example, when D2D user elements 114B-C send signals in a CCCH channel, the cellular user elements (e.g., user element 114A) monitor the CCCH channel and report monitoring results to base station 110A (which may be configured as an eNB). If cellular users element 114A detects CCCH signal information, then that implies that there are D2D user elements (e.g., a pair of D2D user elements 114B-C) close to cellular user element 114A, so the possibility of near-far interference exists. In some implementations, the cellular user element 114A sends to the base station 110A a report (e.g., a message, an information element, etc.) configured as 1-bit of information to signal whether there are D2D pairs nearby. Moreover, additional bits may be used to signal the amount (or level) of interference detected by the cellular user element 114A.

At 394, the base station 110A classifies, based on the information received at 392, cellular user elements into groups. For example, the base station 110A (which is configured as an eNB) may classify cellular user elements into a “non-near-far-risk” and a “near-far-risk.” The cellular user elements classified as “non-near-far-risk” are relatively far away from D2D user elements, so D2D transmission will not interfere with these cellular user elements. However, a near-far-risk user element is close to D2D user elements, and, as such, the user element may receive a relatively large amount of near-far interference from D2D user elements when the same resources are used.

At 396, base station 110A schedules the near-far-risk cellular users to use resources, such as subframes, designated (as “cell specific subframes,” and base station 110A schedules the non-near-far-risk cellular users to use any subframe, i.e., any of the labeled subframes designated as “cell specific subframes” and “shared subframes.” For example, the nodes (e.g., user elements 114A-Q of wireless communication system 100) are classified into two types of subframes, such as a “shared subframe” and a “cellular specific subframe.” The eNB 110A may then schedule the “near-far-risk” cellular user elements only into “cellular specific subframes.” The “non-near-far-risk” cellular user elements may use both “cellular specific subframes” and “shared subframe.”

At 398, the base station 110A broadcasts the labeled subframes to user elements (e.g., sends a message including the “cellular specific subframes” and “shared subframe” as part of a control portion of a frame.) For example, an eNB broadcasts the labeled subframes to D2D user elements, and D2D user elements perform D2D transmissions in the “shared subframes.”

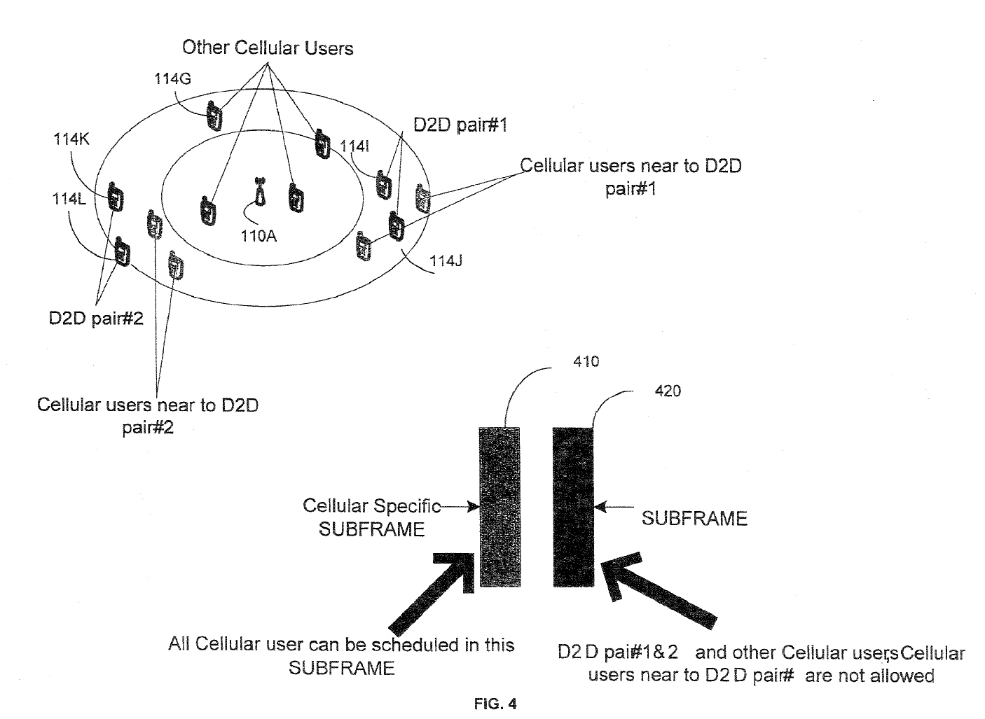

To illustrate further, FIG. 4 depicts base station 110A and user elements configured according to the classification of user elements noted above at 390. For example, a subframe 410 is designated as a “cellular specific subframe” which the base station can schedule any of the cellular user elements. The base station can also designate the shared subframe 420 to D2D user elements (e.g., user elements 114I-J and 114K-L) and to cellular user elements that are non-near-far-risk (e.g., user element 114G and the like). The base station would not schedule the use of the shared subframe 420 to cellular user elements that are a near-far-risk (e.g., user element 114B), as this would likely cause near-far interference.

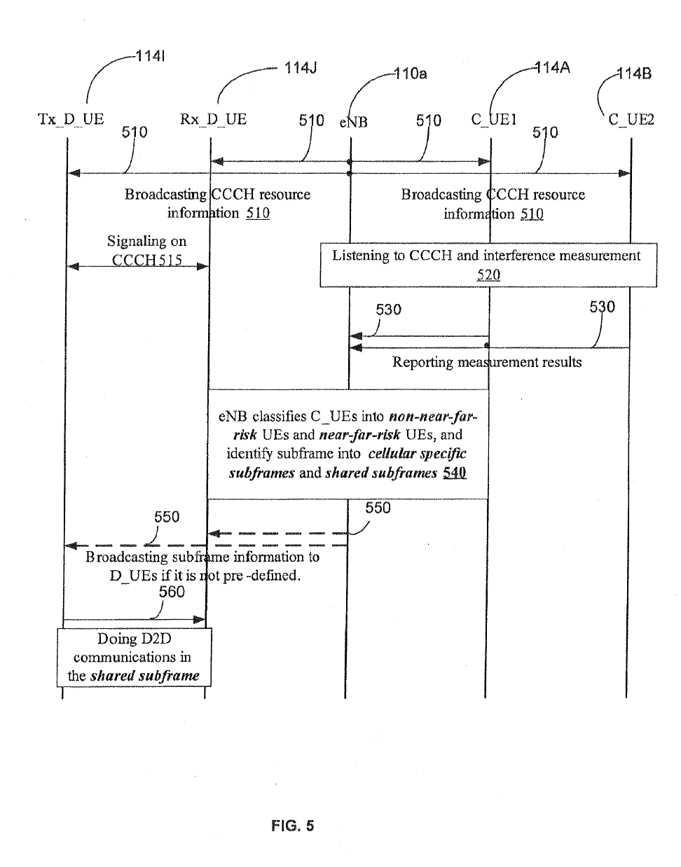

FIG. 5 depicts an example of a process 500 including the messages exchanged among user elements, such as user elements 114A, B, 1 and J, and a base station, such as eNB 110A. The user element 1141 is labeled “Tx_D_user element” to represent a D2D user element that is sending data via a D2D transmission and the label “Rx_D_user element” refers to a D2D user element receiving data via a D2D transmission.

At 510, a base station, such as base station 114A configured as an eNB (herein after referred to as eNB 114A) may send via a broadcast the location of the reserved resources (e.g., time and frequency) including the location of the CCCH configured for D2D signaling. The broadcast by the eNB 114A is received by the cellular user elements 114A-H and D2D user elements 1141-L allowing them to determine the location of the CCCH and thus determine (e.g., detect and thus know) the information included within the CCCH (also referred to as D2D CCCH). The D2D user elements perform signaling, such as a CSMA/CA scheme handshaking scheme, via the D2D CCCH, as noted above.

At 515, signaling occurs on the CCCH between pairs of D2D user elements engaging in D2D transmissions. For example, once D2D transmission starts between a pair of D2D user elements, there is typically some signaling on the CCCH. To illustrate the CCCH signaling, the following example is provided. Initially, the RTS/CTS are transmitted by a D2D user element; a data control (DataCtrl) signal is transmitted (e.g., by a D2D user element) during the D2D transmission between the D2D user elements 114I-J; and then an ACK/NAK is sent by a D2D user element for each packet transmitted via the D2D transmission. As a consequence of this CCCH signaling, the cellular user elements monitoring the CCCH have ample opportunity to hear interference from D2D transmissions.

At 520, cellular user elements 114A-B listen (e.g., periodically receive, monitor, etc.) to signaling on the CCCH. For example, the cellular user elements 114A-B may listen to the RTS/CTS signals transmitted by the D2D user elements. This monitoring by the cellular user elements 114A-B enables a determination of whether the D2D user elements are nearby and a potential source of interference. For example, if cellular user element 114A detects the RTS/CTS, cellular user element 114A may determine that it is close to a D2D user element. Likewise, if cellular user element 114A does not detect the RTS/CTS, cellular user element 114A may determine that it is not near a D2D user element. The listening may be periodic, such as at intervals of 1 ms, 2 ms, 10 ms, although other values may be used as well depending on the configuration provided by the eNB. In some implementations, the cellular user elements 114A-B may make a measurement of the power of detected RTS/CTS signal, and report the measurement to the eNB 110A as an indication of the strength of the interference from the D2D user element(s). Moreover, for a cellular user element in a discontinuous reception (DRX) state, the cellular user element need not measure D2D interference and report the result to the base station.

At 530, cellular user elements may report to eNB information obtained at 520. The information may be reported by cellular user elements as a message, information element, and the like, and sent by the cellular user element via an uplink to the eNB, where the information is received. Once the cellular user element makes sure that the received interference from D2D user elements is beyond a threshold, the cellular user element reports the measurement result to the eNB 110A in the earliest available uplink subframe. In some implementations, that report to the eNB may include as little as 1 bit of information to indicate whether there are D2D pairs nearby, although additional bits of information may be included in the report (or message) to the eNB 110A to report additional information, such as an indication of the level of interference from the D2D user elements.

Table 1 depicts an example of a 1-bit of information reported to a base station, such as eNB 110A. In Table 1, a value of “1” reported from the cellular user element to the eNB 114A represents a high likelihood that there is a D2D user element nearby. In the example of Table 1, the user elements, identified by “C_user element1” and “C_user element4,” are classified as having a high near-far interference risk from a D2D transmission.

TABLE 1
Example of 1-bit reporting format

| ID of C_user element | Interference level |
|---|---|
| C_user element1 | 1 |
| C_user element2 | Low interference, no reporting |
| C_user element3 | Low interference, no reporting |
| C_user element4 | 1 |

At 540, the base station, such as eNB 110A, classifies, based on received information reported by the cellular user elements, one or more (if not all) of the cellular user elements into, for example, two classes, such as a non-near-far-risk and near-far-risk. Correspondingly, the downlink resources (e.g., slots of a radio frame) may be designated into two classes one for the cellular specific subframe and the other for the shared subframes. In some implementations, the cellular specific subframes are used by all cellular user elements, and none of the D2D user elements is allowed to send data in the cellular specific subframe. On the other hand, the shared subframes are used for cellular user elements with non-near-far-risk and D2D user elements. The eNB 110A performs 540 in a manner similar to 394-398 described above with respect to FIG. 3. Table 2 gives the example of the two groups classified by eNB 110A at 540.

TABLE 2
Example of classifying all cellular user elements

| | | | | |
|---|---|---|---|---|
| Cellular user | C_user | C_user | C_user | . . . |
| elements with non- | element1 | element3 | element5 | |
| near-far-risk | | | | |
| Cellular user | C_user | C_user | C_user | . . . |
| elements with near- | element2 | element4 | element6 | |
| far-risk | | | | |

The eNB schedules near-far-risk cellular users only into cellular specific subframes, but freely schedules all the remaining cellular user elements into both cellular specific subframes and shared subframes. The eNB schedules D2D user elements to use only the shared subframes. Multiple D2D user element pairs may share resources spatially by using the normal RTS/CTS procedure.

At 550, the base station, such as eNB 114A, sends by, for example, a broadcast, the subframes schedule determined in 540. In some cases, the scheduled subframes may be provided during the initial power on stage of a cellular user element. For example, the wireless communication system 100 may be configured such that when the cellular user element is in non-near-far-risk class, the eNB changes its scheduling decision according to a subsequent interference report from that user element. The eNB will then broadcast available subframe information (e.g., shared subframes) for one or more (if not all) of the D2D user elements in advance. The reserved number of shared subframes may be determined in a variety of ways. For example, only a predefined, static number of subframes in a radio frame may be allocated to a D2D user element in control messages (e.g., 210A-B at FIG. 2). In another example, the allocated subframes is allocated in a control message based on the traffic experienced by the cellular user elements and D2D user elements, in which case the allocation is updated from time to time. The allocated subframe may be continuous or discontinuous. The D2D user elements may be configured to require the eNB to allocate a sufficient amount of subframes.

Table 3 depicts an example of allocated subframe information. Referring to Table 3, in a 10 ms frame, downlink subframe 2 and 8 are shared subframes and the other subframes are cellular specific subframe in which no D2D transmissions are allowed. In the example of Table 3, the subframes each correspond to about 1 millisecond, although other sizes may be used for the subframe.

TABLE 3
Example of labeled subframes (“C” represents cellular specific
subframe, and “S” represents a shared subframe.)

| Subframe Number | 0 | 1 | 2 | 3 | 4 | 5 | 6 | 7 | 8 | 9 |
|---|---|---|---|---|---|---|---|---|---|---|
| Downlink subframe | D | D | D | D | D | D | D | D | D | D |
| Attribute | C | C | S | C | C | C | C | C | S | C |

At 560, the D2D user elements begin transmission on resources shared with the downlink between the base station and the cellular user elements without near-far interference.

In some implementations, to reduce the signaling overhead, the cellular user elements report interference detected on the CCCH only when the interference from the CCCH exceeds a power threshold. Moreover, the cellular user element may include in its report to the base station at 530 only the identifier of the cellular user element and interference information (e.g., 1 bit, 2-bits, and the like). The reported measurement results (from the monitoring at 520) may be transmitted to the base station in a variety of radio formats, including time division multiplexing, frequency division multiplexing, or code division multiplexing on a dedicated channel.

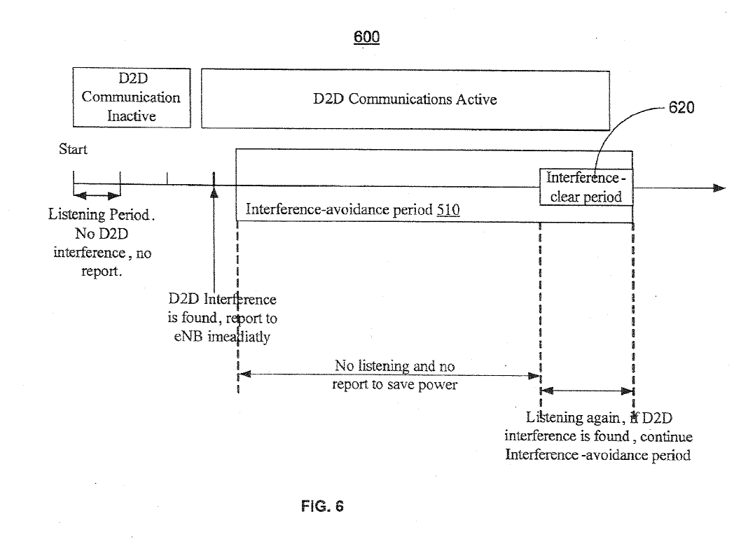

FIG. 6 depicts an example of a power saving process 600 that may be implemented at the cellular user elements. For example, given that D2D transmission lasts a given period of time and given that during the D2D transmission it is unnecessary for cellular user elements to periodically listen, a power saving scheme may be implemented as described below with respect to FIG. 6.

Referring to FIG. 6 two periods, namely, interference-avoidance period 610 and interference-clear period 620 are defined by a base station, such as eNB 114A. The interference-avoidance period 610 and the interference-clear period 620 are broadcasted by the base station to cellular user elements in advance of those periods 610 and 620. During interference-avoidance period 610, the D2D user elements are active and cellular user elements (close to an interfering D2D user element) do not need to listen to the CCCH to assess whether there is D2D interference. Interference-clear period 620 is at the end of the interference-avoidance period 610, during which, cellular user elements measure D2D interference and send a near-far-risk indication or not, depending on whether there are CCCH signals in the most recent interference-clear period. As shown in FIG. 6, since no CCCH signals are detected at the end of interference-clear period 620, interference-avoidance period 610 ends, and cellular user elements continue to listen to D2D CCCH in, for example, a periodic manner.

In some implementations, one or more of the following advantages may be realized. First, the cellular user elements may obtain, with a relatively high likelihood, information representing whether they are experiencing interference from nearby D2D transmissions by measuring the CCCH used by the D2D user elements. This information allows the cellular user elements and D2D user elements to share resources, e.g., subframes, frequencies, OFDMA symbols, and the like, of the downlink from the base station (or eNB). Second, the labeled subframes may avoid near-far interference effectively and such information can be updated flexibly according to the real traffic and network situation such that the efficiency can be enhanced, if not guaranteed.

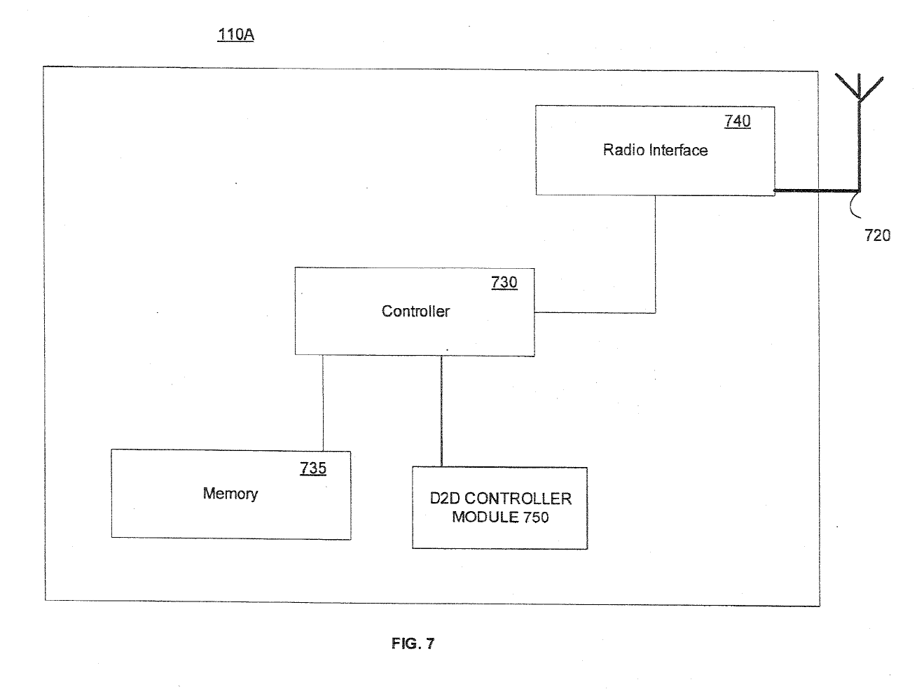

FIG. 7 depicts an example implementation of a base station 110A, such as base stations 110A-B. The base station 110A includes an antenna 720 configured to transmit via a downlink, such as downlink 116A and configured to receive uplinks, such as uplink 126A via the antenna(s) 720. The base stations 110A-B further includes a radio interface 740 coupled to the antenna 720, a processor 730 for controlling the base station 110A and for accessing and executing program code stored in memory 735. The radio interface 740 further includes other components, such as filters, converters (e.g., digital-to-analog converters and the like), mappers, a Fast Fourier Transform (FFT) module, and the like, to generate symbols for a transmission via one or more downlinks and to receive symbols (e.g., via an uplink). In some implementations, the base station 110A is also compatible with IEEE 802.16, LTE, and the like, and the RF signals of downlinks and uplinks are configured as an OFDMA signal.

Furthermore, the base station 110A may include a D2D controller 750. The D2D controller 750 may be configured to perform one or more of the aspects not above with respect to processes 390, 500, and 600 (e.g., those aspects associated with the eNB and/or base station). Moreover, the D2D controller 750 may provide information to the user elements to control power, as describe above with respect to FIG. 6. Furthermore, the D2D controller 750 may send via the downlink from the base station to a D2D user element the resource allocations (e.g., subframes, frequencies, OFDMA symbols, etc.) to be used by the cellular user elements and D2D user elements. The resource allocation may be provided during the control portion of a subframe (e.g., 210A-B), and updated dynamically according to the state of the wireless communication system 100 (e.g., traffic experienced by the cellular user elements and D2D user elements).

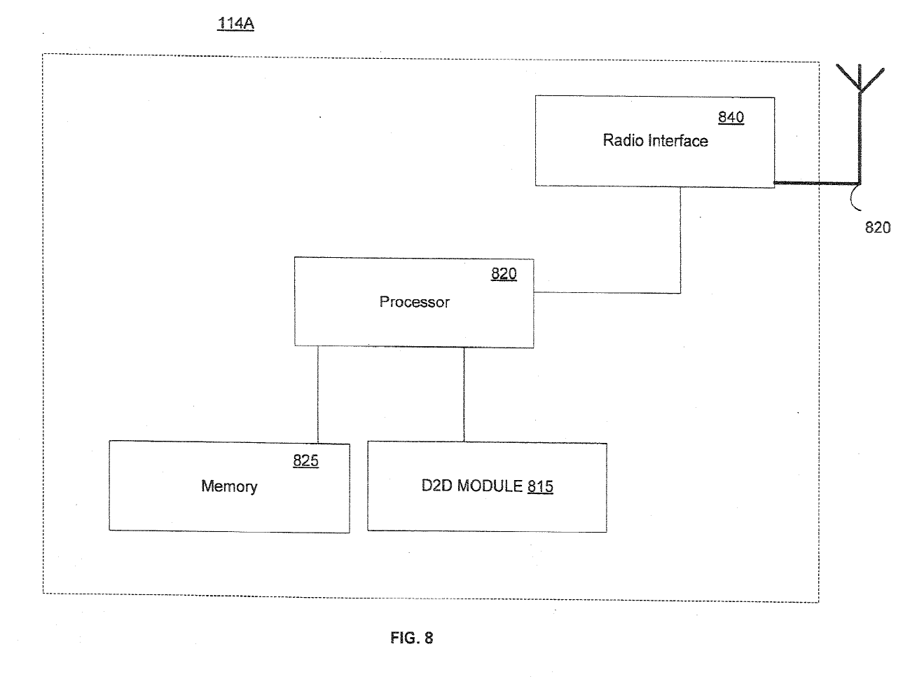

FIG. 8 depicts an exemplary user element, such as user element 114A. The user element 114A includes an antenna 820 for receiving a downlink and transmitting via an uplink. The user element 114A also includes a radio interface 840, which may include other components, such as filters, converters (e.g., digital-to-analog converters and the like), symbol demappers, an Inverse Fast Fourier Transform (IFFT) module, and the like, to process symbols, such as OFDMA symbols, carried by a downlink or an uplink. In some implementations, the user element 114A is also compatible with IEEE 802.16, LTE, LTE-Advanced, and the like. The user element 114A further includes a processor 820 for controlling client station 114A and for accessing and executing program code stored in memory 825.

Furthermore, the user element 114A may include a D2D module 815. The D2D module may be configured to perform one or more of the aspects not above with respect to processes 390, 500, and 600 (e.g., those aspects associated with the user element). For example, the D2D module 815 may monitor the CCCH channel as described above and report any activity to the base station. The report to the base station may be a 1-bit indication representing that there is activity, although additional bits may be used (e.g., to provide an indication of power level). Moreover, the D2D module 815 may control transmission by the user element in accordance with the allocation of resources (e.g., subframes, frequency, OFDMA symbols, etc.) provided by the base station. For example, the D2D module 815 may control transmission in the cellular specific subframe or the shared subframe, although this transmission control may be configured to control frequency, OFDMA symbols, and the like. D2D controller 750 may provide information to the user elements to control power, as describe above with respect to FIG. 6. Furthermore, the D2D module 815 may be configured to signal via the CCCH in a D2D mode. The D2D module 815 may switch the mode of the user element between a D2D user element and a cellular user element.

The subject matter described herein may be embodied in systems, apparatus, methods, and/or articles depending on the desired configuration. For example, the base stations and/or user elements (or one or more components therein) and//or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1.-18. (canceled)

19. A method comprising:
receiving, at a base station, information from a user element, the information including at least one bit representing whether direct transmissions between pairs of user elements cause interference to the user element; and
scheduling, based at least in part on the received information, the user element into at least one of a first subframe, when the received information indicates a risk of interference from the direct transmissions between the pairs of user elements, and into a second subframe, when the received information indicates no risk of interference from the direct transmissions between the pairs of user elements.

20. The method of claim 19, wherein receiving further comprises:
receiving an indication of a power level of the direct transmissions between the pairs of user elements.

21. The method of claim 19 further comprising:
classifying, based at least in part on the received information, the user element as a near-far interference risk.

22. The method of claim 19 further comprising:
sending, by the base station, an indication, the indication including information defining subframes configured to be used by a first set of user elements engaging in direct transmissions and a second set of user elements engaging in transmission with the base stations.

23. A method comprising:
monitoring, by a user element, a channel used to signal direct transmissions between a pair of user elements; and
sending, by the user element to a base station, a message reporting information monitored from the channel, the message including at least one bit representing whether direct transmissions causing interference are near the user element.

24. The method of claim 23 further comprising:
transmitting, by the user element, in accordance with an allocation of at least one of a subframe and a frequency, the allocation provided by the base station being based on the monitored information.

25. An apparatus comprising:
at least one processor; and
at least one memory including computer program code, the at least one memory and the computer program code configured to, with the at least one processor, cause the apparatus at least to perform:
receiving, at a base station, information from a user element, the information including at least one bit representing whether direct transmissions between pairs of user elements cause interference to the user element; and
scheduling, based at least in part on the received information, the user element into at least one of a first subframe, when the received information indicates a risk of interference from the direct transmissions between the pairs of user elements, and into a second subframe, when the received information indicates no risk of interference from the direct transmissions between the pairs of user elements.

26. The apparatus of claim 25, wherein receiving further comprises:
receiving an indication of a power level of the direct transmissions between the pairs of user elements.

27. The apparatus of claim 25, wherein the apparatus is further caused to perform:
classifying, based at least in part on the received information, the user element as a near-far interference risk.

28. The apparatus of claim 25, wherein the apparatus is further caused to perform:
sending, by the base station, an indication, the indication including information defining subframes configured to be used by a first set of user elements engaging in direct transmissions and a second set of user elements engaging in transmission with the base stations.

29. An apparatus comprising:
at least one processor; and
at least one memory including computer program code, the at least one memory and the computer program code configured to, with the at least one processor, cause the apparatus at least to perform:
monitoring, by a user element, a channel used to signal direct transmissions between a pair of user elements; and
sending, by the user element to a base station, a message reporting information monitored from the channel, the message including at least one bit representing whether direct transmissions causing interference are near the user element.

30. The apparatus of claim 29, wherein the apparatus is further caused to perform:
transmitting, by the user element, in accordance with an allocation of at least one of a subframe and a frequency, the allocation provided by the base station being based on the monitored information.

31. A computer-readable storage medium containing instructions to configure a processor to perform a process comprising:
receiving, at a base station, information from a user element, the information including at least one bit representing whether direct transmissions between pairs of user elements cause interference to the user element, and
scheduling, based at least in part on the received information, the user element into at least one of a first subframe, when the received information indicates a risk of interference from the direct transmissions between the pairs of user elements, and into a second subframe, when the received information indicates no risk of interference from the direct transmissions between the pairs of user elements.

32. The computer-readable storage medium of claim 31, wherein receiving further comprises:
receiving an indication of a power level of the direct transmissions between the pairs of user elements.

33. The computer-readable storage medium of claim 31 further comprising:
classifying, based at least in part on the received information, the user element as a near-far interference risk.

34. The computer-readable storage medium of claim 31 further comprising:
sending, by the base station, an indication, the indication including information defining subframes configured to be used by a first set of user elements engaging in direct transmissions and a second set of user elements engaging in transmission with the base stations.

35. A computer-readable storage medium containing instructions to configure a processor to perform a process comprising:
monitoring, by a user element, a channel used to signal direct transmissions between a pair of user elements; and
sending, by the user element to a base station, a message reporting information monitored from the channel, the message including at least one bit representing whether direct transmissions causing interference are near the user element.

36. The computer-readable storage medium of claim 35 further comprising:
transmitting, by the user element, in accordance with an allocation of at least one of a subframe and a frequency, the allocation provided by the base station being based on the monitored information.
